(19) United States
(12) Patent Application Publication
(10) Pub. No.: US 2013/0238976 A1
(43) Pub. Date: Sep. 12, 2013

(54) INFORMATION PROCESSING APPARATUS, INFORMATION PROCESSING METHOD, AND COMPUTER PROGRAM

(71) Applicant: SONY CORPORATION, Tokyo (JP)

(72) Inventors: Kiyoto ICHIKAWA, Tokyo (JP); Satoshi Asakawa, Tokyo (JP); Ugo Di, Kanagawa (JP); Keiichi Yamada, Tokyo (JP)

(73) Assignee: Sony Corporation, Tokyo (JP)

(21) Appl. No.: 13/782,368

(22) Filed: Mar. 1, 2013

(30) Foreign Application Priority Data
Mar. 7, 2012 (JP) 2012-050276

(51) Int. Cl. G06F 17/22

(52) U.S. Cl. CPC G06F 17/2247
USPC 715/234

(57) ABSTRACT

There is provided an information processing apparatus including: a selectable part analyzing unit analyzing selectable parts in a webpage displayed in a display area of a display unit; and a layout processing unit rearranging the selectable parts as selection objects in an operation area.

### BACKGROUND

The present disclosure relates to an information processing apparatus, an information processing method, and a computer program that provide an interface with high operability.

Compared to operations made using an existing interface, it is more intuitive for a user to operate an appliance, GUI, or the like using gestures as described in Japanese Laid-Open Patent Publication No. 2011-209787 for example.

### SUMMARY

However, if the operated target is far from the user or if the operated target is small, it is necessary to make precise operations that are difficult to make using gestures. There are also cases where, due to environmental factors or the like, the recognition accuracy for gestures deteriorates, resulting in an inability to make the correct operation. In addition, in cases such as when the user clicks a small link in a selection region on a website or when an operation is made in a region in which operable parts are closely spaced, the user will sometimes operate an unintended part.

If, in this way, the correct operation cannot be made, the user will have to repeat the operation several times until the operation can be completed, which can reduce the user's motivation to use an apparatus. If operations are made using large movements such as hand gestures, there is also a physical demand upon the user, which can result in the user's arm tiring. For this reason, there is demand for a new interface that enables selection operations to be made easily without requiring precise operations.

According to an embodiment of the present disclosure, there is provided an information processing apparatus including a selectable part analyzing unit analyzing selectable parts in a webpage displayed in a display area of a display unit, and a layout processing unit rearranging the selectable parts as selection objects in an operation area.

Further, according to an embodiment of the present disclosure, there is provided an information processing method including analyzing selectable parts in a webpage displayed in a display area of a display unit, and rearranging the selectable parts as selection objects in an operation area.

Further, according to an embodiment of the present disclosure, there is provided a computer program causing a computer to function as an information processing apparatus including a selectable part analyzing unit analyzing selectable parts in a webpage displayed in a display area of a display unit, and a layout processing unit rearranging the selectable parts as selection objects in an operation area.

As described above, according to the embodiments of the present disclosure, it is possible to realize a new interface that enables selections to be made easily without requiring precise operations.

### BRIEF DESCRIPTION OF THE DRAWINGS

FIG. 1 is a block diagram showing the overall configuration of an information processing apparatus according to a first embodiment of the present disclosure;

FIG. 2 is a block diagram showing the configuration of a data processing unit of the information processing apparatus according to the same embodiment;

FIG. 3 is a flowchart showing the layout process for the operation area carried out by the information processing apparatus according to the same embodiment;

FIG. 4 is a diagram useful in explaining an example of the operation area laid out by the information processing apparatus according to the same embodiment;

FIG. 5 is a diagram useful in explaining an example operation in the operation area shown in FIG. 4;

FIG. 6 is a diagram useful in explaining another example arrangement of the operation area shown in FIG. 4;

FIG. 7 is a diagram useful in explaining an example of an operation gesture;

FIG. 8 is a diagram useful in explaining a case where an area including the position indicated by the cursor is enlarged and displayed as an operation area;

FIG. 9 is a diagram useful in explaining another example case where an area including the position indicated by the cursor is enlarged and displayed as an operation area;

FIG. 10 is a diagram useful in explaining gesture sensing areas;

FIG. 11 is a diagram useful in explaining an example of an operation area laid out on a small-scale terminal;

FIG. 12 is a diagram useful in explaining another example of an operation area laid out on a small-scale terminal;

FIG. 13 is a diagram useful in explaining another example of an operation area laid out for an operation screen of a music playback application;

FIG. 14 is a diagram useful in explaining another example of an operation area laid out for an operation screen of a music playback application; and

FIG. 15 is a block diagram showing an example hardware configuration of the information processing apparatus according to the same embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description is given in the order indicated below.

### 1. Configuration of Information Processing Apparatus

### 2. Layout Process for Operation Area

2-1. Layout Process for Operation Area on a Webpage

2-2. Variations for Operation Area

### 3. Example Hardware Configuration

### 1. Configuration of Information Processing Apparatus

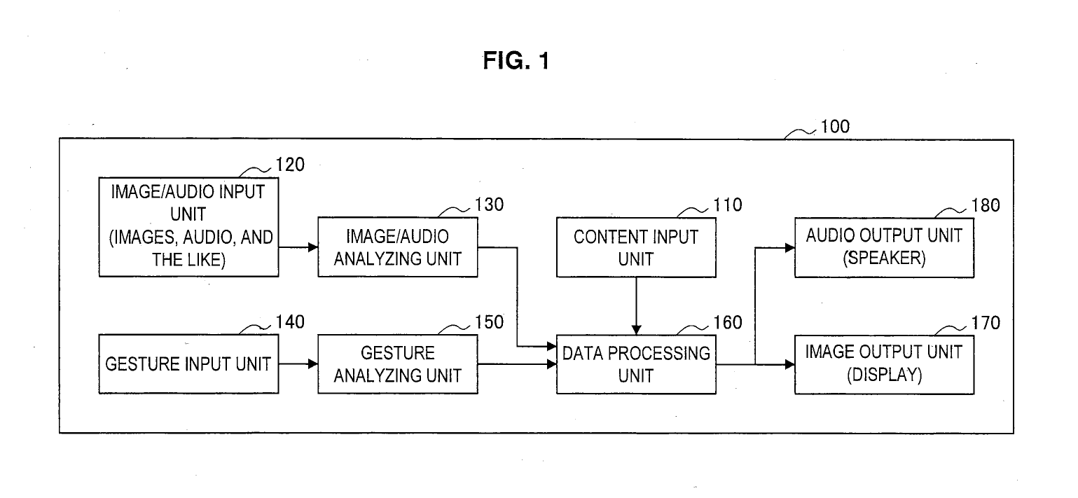

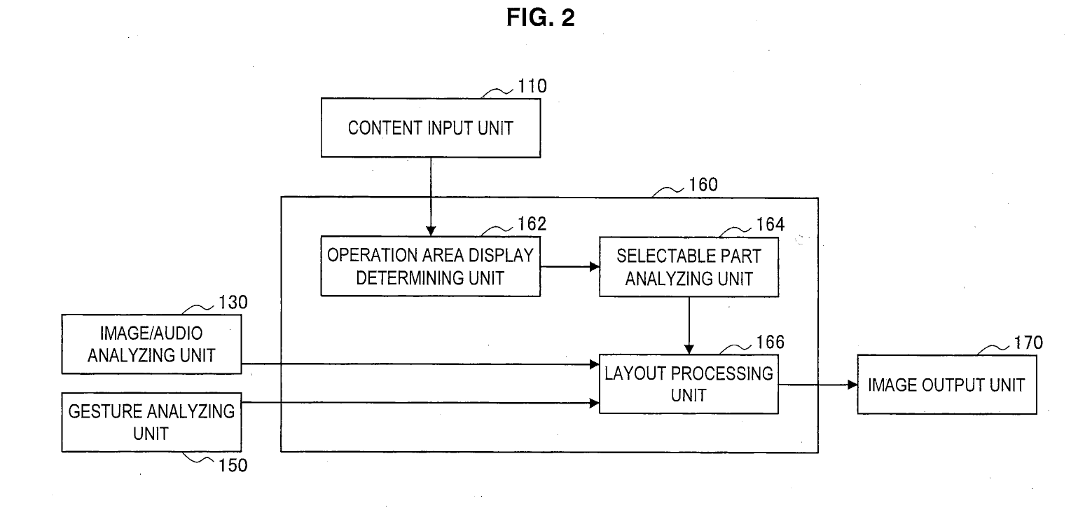

First, the overall configuration of an information processing apparatus according to a first embodiment of the present disclosure will be described with reference to FIGS. 1 and 2. FIG. 1 is a block diagram showing the overall configuration of an information processing apparatus 100 according to the present embodiment. FIG. 2 is a block diagram showing the configuration of a data processing unit 160 in the information processing apparatus 100 according to the present embodiment.

The information processing apparatus 100 according to the present embodiment is an apparatus where operations are made on a website, content such as video or music, or the like using operation input information which mainly relates to gestures but depending on the application could also be an audio input (such as speech) or the like. As shown in FIG. 1, the information processing apparatus 100 includes a content input unit 110, an image/audio input unit 120, an image/audio analyzing unit 130, a gesture input unit 140, a gesture analyzing unit 150, the data processing unit 160, an image output unit 170, and an audio output unit 180.

The content input unit 110 is an interface into which content that is an operation target is inputted. The content input unit 110 receives a webpage or content such as images and music inputted from an appliance or the like connected to the information processing apparatus 100 and outputs such website or content to the data processing unit 160.

The image/audio input unit 120 enables operation inputs to be made via audio or images for the content inputted from the content input unit 110. The image/audio input unit 120 receives an operation input such as an audio operation (for example, a speech operation) or an operation of touching or approaching an image display surface in accordance with an application and outputs operation input information to the image/audio analyzing unit 130.

The image/audio analyzing unit 130 analyzes the operation content carried out by the user based on the operation input information inputted from the image/audio input unit 120. If the operation input information is speech for example, the image/audio analyzing unit 130 analyzes the operation content indicated by the user through speech analysis. If the operation input information is for an operation where the user touches or approaches an image display surface, the image/audio analyzing unit 130 specifies the touched or approached position on the image display screen and specifies a part displayed at the corresponding position as the operation target. In this way, on analyzing the operation content according to the operation input information inputted from the user, the image/audio analyzing unit 130 outputs an analysis result to the data processing unit 160.

The gesture input unit 140 acquires a gesture made by the user as operation input information. The gesture input unit 140 may be an image pickup apparatus that picks up an image of the user making a gesture, for example, or may be a sensor capable of recognizing a spatial position of a part of the user's body making an operation. The gesture input unit 140 outputs the acquired operation input information to the gesture analyzing unit 150.

The gesture analyzing unit 150 analyzes the content of the operation carried out by the user based on the operation input information inputted from the gesture input unit 140. More specifically, the gesture analyzing unit 150 analyzes movement and the like from positional changes in the part of the user making the operation input and specifies the content of the operation indicated by the user. On analyzing the content of the operation from the operation input information inputted from the user, the gesture analyzing unit 150 outputs the analysis result to the data processing unit 160.

The data processing unit 160 carries out a display process for the content inputted from the content input unit 110 based on an analysis result inputted from the image/audio analyzing unit 130 and/or the gesture analyzing unit 150. In a system that uses gestures or touch operations, if the operation target is far from the user and/or is small, precise operations become necessary. There are also cases where, due to environmental factors or the like, the recognition accuracy for gestures deteriorates, resulting in difficulty in making correct operations.

For this reason, the data processing unit 160 according to the present embodiment increases the size of and rearranges selectable objects included in the content displayed on the image output unit 170, described later, in an operation area where the user makes an operation input so that the user can easily select such objects. By doing so, it is possible to improve the operability for content where operations are difficult. More specifically, as shown in FIG. 2, the data processing unit 160 includes an operation area display determining unit 162, a selectable part analyzing unit 164, and a layout processing unit 166.

The operation area display determining unit 162 determines whether to rearrange the selectable parts included in the content displayed on the image output unit 170 in an operation area that differs to the display area in which the content is displayed as normal. As one example, if selectable parts are present in the content displayed in the display area, the operation area display determining unit 162 may rearrange and display such selectable parts in an operation area. Alternatively, if selectable parts are concentrated in the content or if the character size of the selectable parts is equal to or below a specified size, the operation area display determining unit 162 may rearrange and display such selectable parts in an operation area. On deciding to display an operation area, the operation area display determining unit 162 instructs the selectable part analyzing unit 164 to carry out a process that specifies the selectable parts to be rearranged in the operation area.

The selectable part analyzing unit 164 specifies the selectable parts to be rearranged in the operation area out of the selectable parts included in the content. The selectable part analyzing unit 164 analyzes the composition of the content and extracts selectable parts. The selectable part analyzing unit 164 then outputs information on the extracted selectable parts to the layout processing unit 166.

The layout processing unit 166 rearranges and displays the selectable parts extracted by the selectable part analyzing unit 164 in an operation area on the image output unit 170. The layout processing unit 166 disposes the selectable parts of the content in the operation area so as to be larger than the original selectable parts displayed in the display area and therefore easier to operate via a gesture, touch operation, or the like made by the user. The process that rearranges the selectable parts in the operation area will be described in detail later in this specification. By making an operation input for a selection object rearranged in the operation area, it is possible for the user to carry out an operation that selects a selectable part of the content displayed in the display area.

At such time, the layout processing unit 166 may produce a display showing the correspondence between the selection object selected in the operation area and a selectable part of the content displayed in the display area. As the display showing such correspondence, as conceivable examples it would be possible to surround the selection object selected in the operation area and the corresponding selectable part of the content displayed in the display area with the same type of frame or to display both the selection object and the selectable part using the same color. The layout processing unit 166 acquires the content of an operation made by the user from the image/audio analyzing unit 130 or the gesture analyzing unit 150. If the position selected by the user is inside the operation area, the layout processing unit 166 produces a display showing the correspondence between the selection object selected in the operation area and the corresponding selectable part of the content. By doing so, it is possible for the user to easily recognize what part of the content corresponds to the part selected in the operation area.

The layout processing unit 166 outputs layout information of the generated operation area, correspondence information for the selection object selected in the operation area and the corresponding selectable part in the display area, and the like to the image output unit 170 to have such information displayed. If the displayed content also includes audio information, the layout processing unit 166 outputs the audio information to the audio output unit 180.

The image output unit 170 is a display unit that carries out displaying based on the layout information, correspondence information, and the like inputted from the layout processing unit 166. As the image output unit 170, as examples it is possible to use a liquid crystal display or an organic EL display.

The audio output unit 180 outputs the audio information inputted from the layout processing unit 166. As the audio output unit 180, as one example it is possible to use an audio output apparatus, such as a speaker.

### 2. Layout Process for Operation Area

2-1. Layout Process for Operation Area on a Webpage

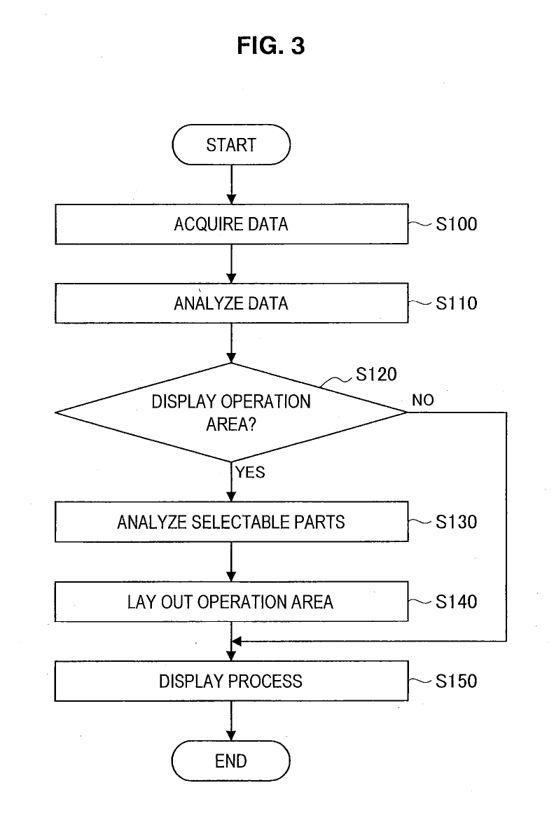

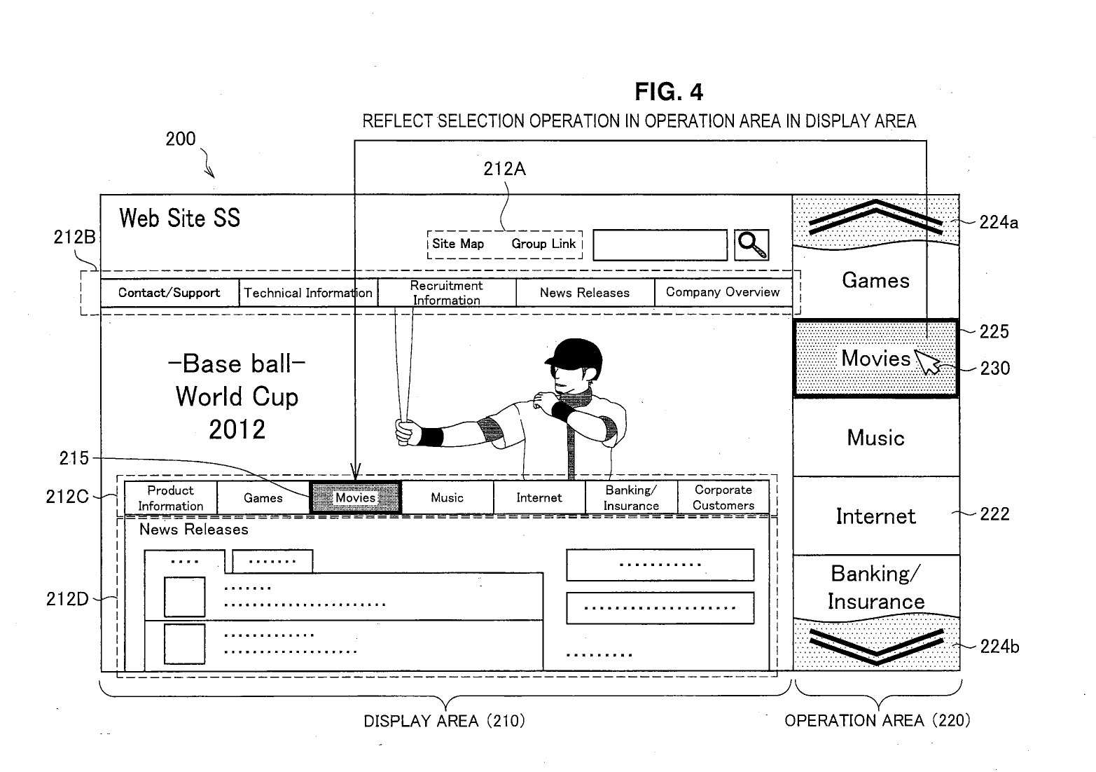

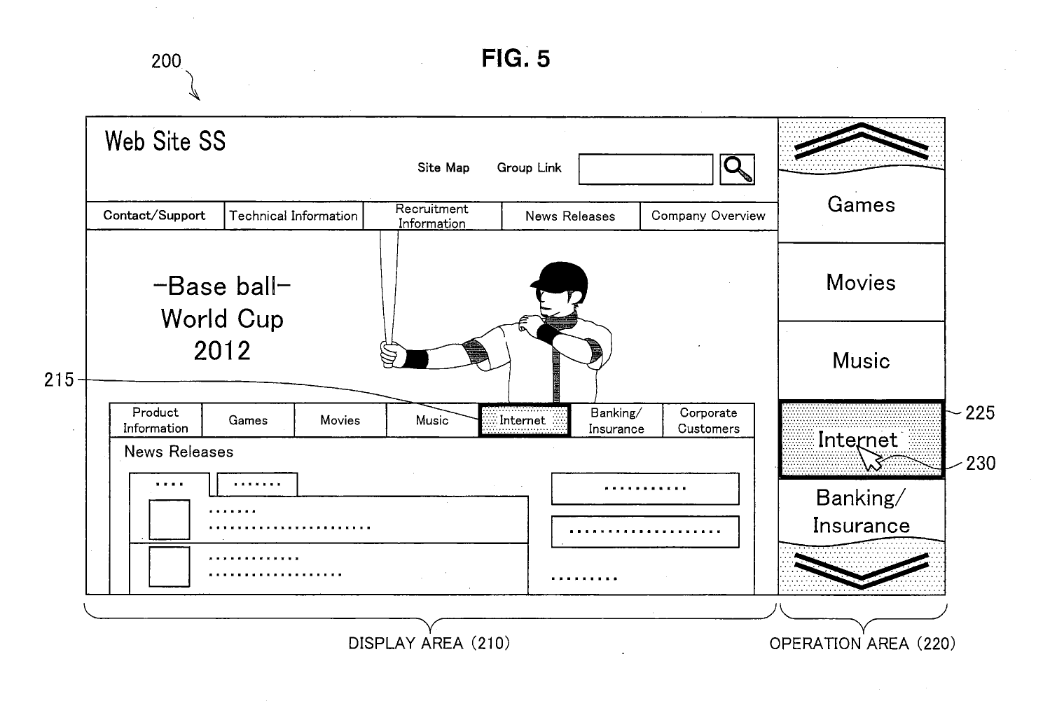

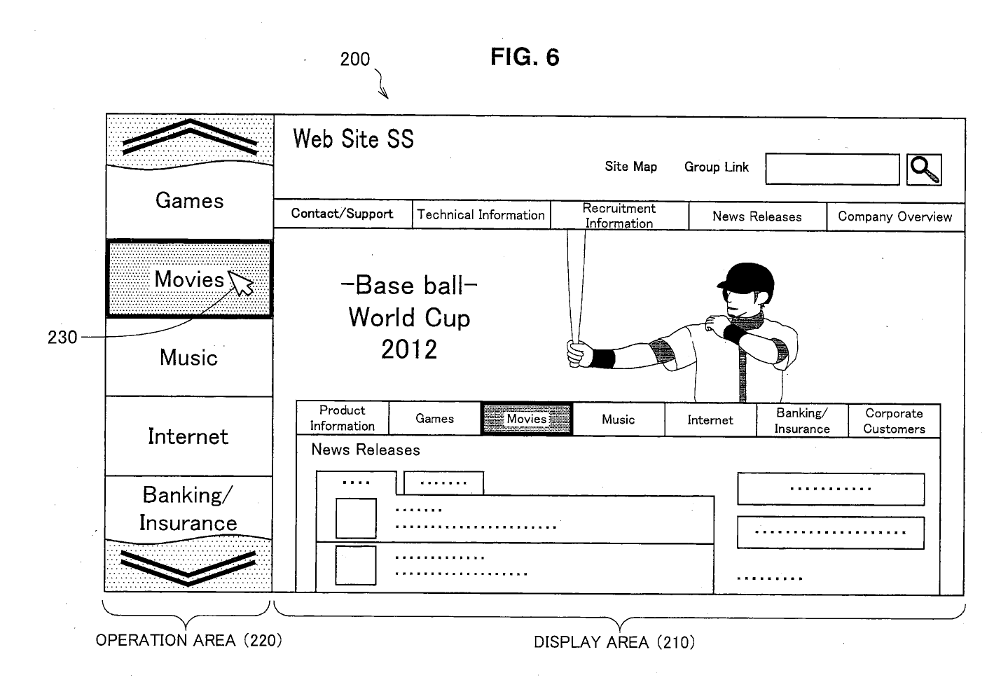

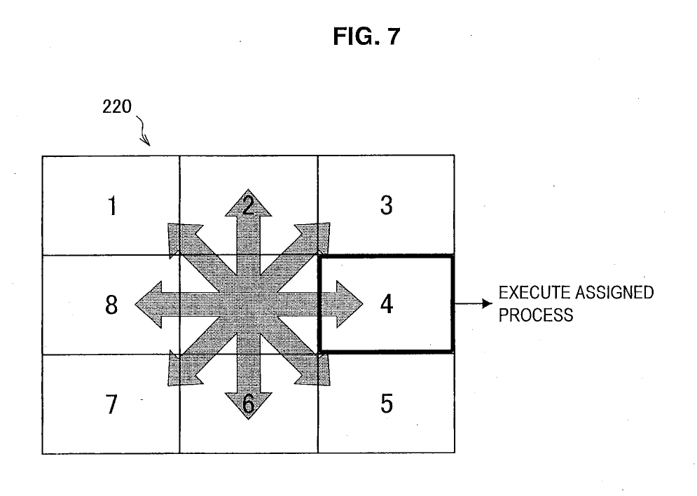

To make it easier to select selectable parts included in the content displayed in the display area of the image output unit 170, the information processing apparatus 100 according to the present embodiment rearranges such selectable parts as selection objects in the operation area. The layout process for the operation area carried out by the information processing apparatus 100 according to the present embodiment will now be described with reference to FIGS. 3 to 7. FIG. 3 is a flowchart showing the layout process for the operation area carried out by the information processing apparatus 100 according to the present embodiment. FIG. 4 is a diagram useful in explaining an example of an operation area laid out by the information processing apparatus 100 according to the present embodiment. FIG. 5 is a diagram useful in explaining an example operation in the operation area shown in FIG. 4. FIG. 6 is a diagram useful in explaining another example arrangement of the operation area shown in FIG. 4. FIG. 7 is a diagram useful in explaining one example of an operation gesture.

As shown in FIG. 3, the layout process for the operation area carried out by the information processing apparatus 100 according to the present embodiment starts with content data expressing the content to be outputted to the image output unit 170 being acquired from the image output unit 170 (S 100). On acquiring the content data, the content input unit 110 outputs the content data to the data processing unit 160.

Next, the data processing unit 160 analyzes, via the operation area display determining unit 162, whether selectable parts are included in the acquired content data (S 110). In step S110, the content data is analyzed to determine whether the selectable parts included in the content displayed in the display area are to be rearranged in an operation area that differs to the display area. Based on the analysis result, the operation area display determining unit 162 determines whether to carry out the layout process that rearranges the selectable parts included in the content in the operation area (S 120).

As examples, the determination in step S120 can be carried out in accordance with whether selectable parts are present in the content displayed in the display area, whether selectable parts are concentrated in the content, or whether the character size of the selectable parts is equal to or below a specified size. For example, if selectable parts are present in the content, it is possible to carry out the processing in steps S130, S140 described later and rearrange and display such selectable parts in the operation area. If, in the content displayed in the display area, the number of selectable parts in a specified area is a specified number or higher, it is possible to determine that the selectable parts are concentrated and to rearrange and display such selectable parts in the operation area. Alternatively, it is possible to rearrange and display the selectable parts in the operation area if the character size of the selectable parts in the content is equal to or below a specified size.

That is, on determining that it is difficult to select the selectable parts included in the content using a gesture, a touch operation, or the like, the operation area display determining unit 162 rearranges the selectable parts in an operation area to make it easier for the user to carry out a selection operation. If it is decided in step S120 to display an operation area and rearrange the selectable parts of the content, the selectable part analyzing unit 164 specifies the selectable parts to be rearranged in the operation area (S130). The selectable parts are link parts that have links from source data of the content and the selectable part analyzing unit 164 acquires selectable parts to be rearranged in the operation area by extracting such link parts.

As one example, as shown in FIG. 4, a webpage that is one example of content is displayed on an image display screen 200 of the image output unit 170. The image display screen 200 includes a display area 210 in which content is displayed as normal and an operation area 220 in which selectable parts included in the content are rearranged and displayed as selection objects. In the example shown in FIG. 4, the display area 210 and the operation area 220 are provided on the same screen of the image output unit 170. By doing so, it becomes easier for the user to view the display area 210 and the operation area 220 at the same time and easier to recognize the correspondence between an operation in the operation area 220 and an operation position in the display area 210. Note that it is also possible for the operation area 220 to be displayed only when a decision to display the operation area 220 has been taken in step S120, with only the display area 210 being displayed on the image display screen 200 of the image output unit 170 when such decision has not been taken.

As one example, the webpage displayed in the display area 210 shown in FIG. 4 includes a link part 212A to “Site Map” and “Group Link” and a link part 212B to “Contact/Support”, “Technical Information”, and the like. In addition, the webpage includes a link part 212C to “Product Information”, “Games”, “Movies”, “Music”, and the like and as one example a detailed information display area 212D in which an item selected in the link parts 212B, 212A is displayed. The information displayed in the detailed information display area 212D may also include link parts with links to other webpages. In step S130, such link parts in a webpage like the illustrated example are extracted from the source data.

If selectable parts are specified in step S130, the layout processing unit 166 rearranges the selectable parts as selection objects in the operation area 220 (S 140). As shown in FIG. 4 for example, selection candidate parts specified from the content are arranged and displayed in a line (here, a column) as selection objects 222 in the operation area 220. At this time, by making the size of the selection objects 222 in the operation area 220 larger than the size of the respective selectable parts in the display area 210, the regions for recognizing operations are enlarged and it becomes possible for the user to select a desired selectable part without making a precise operation input.

When the number of selectable parts extracted from the display area 210 is large, there will be a corresponding increase in the number of selection objects 222, so that if the size of the selection objects 222 in the operation area 220 is increased, it will not be possible to display all of the selection objects 222 in the operation area 220. In this case, as shown in FIG. 4 for example, only some out of the plurality of selection objects 222 to be displayed in the operation area 220 are displayed at a specified size. To display the selection objects 222 that do not fit in the operation area 220, scroll buttons 224a, 224b are provided in the operation area 220 so that by pressing such buttons, the user can scroll the selection objects 222 arranged in a column in the operation area 220 in a specified direction. By doing so, even when a large number of selectable parts are included in the content, it is possible to display every selection object corresponding to the selectable parts in a selectable manner in the operation area 220.

Once the layout of the operation area 220 has been decided in step S140, the layout processing unit 166 displays the operation area 220 on the image output unit 170 (S150). By doing so, as shown in FIG. 4 for example, the content is displayed as normal in the display area 210 and the selectable parts included in the content are also displayed in the operation area 220 as selection objects 222. The information displayed in the image display screen 200 can be operated by a cursor 230 used to operate such information and the cursor 230 can be moved by a gesture by the user or a touch operation on the image display screen 200. The user may move the cursor 230 and directly operate a selectable part displayed on the display area 210 or may operate the content displayed in the display area 210 by operating a selection object 222 in the operation area 220.

Here, when a selection object 222 in the operation area 220 has been operated by the cursor 230, the layout processing unit 166 carries out a correspondence display process that shows the correspondence between the selected selection object 222 and the corresponding selectable part in the content. As shown in FIG. 4 for example, the correspondence display may attach the same type of frame 225, 215 to the selection object 222 currently selected by the cursor 230 and the selectable part corresponding to such object and/or may highlight both the selected selection object 222 and the selectable part in the same way. By carrying out such a correspondence display, it is possible for the user to easily recognize what part of the content is being operated in the operation area 220, which improves operability for the operation area 220.

As shown in FIG. 5 for example, assume that the correspondence display changes from the state in FIG. 4 where the “Movies” selection object 222 is selected to a state where the “Internet” selection object 222 is selected. When doing so, in keeping with the change in the selection object 222 that is currently selected, the position of the correspondence display (the frames 225, 215) of the corresponding selectable part in the content displayed in the display area 210 also changes.

This completes the description of the layout process for the operation area carried out by the information processing apparatus 100 according to the present embodiment. In this way, the image display screen 200 is provided with the display area 210 that displays content such as a webpage and also the operation area 220 in which selectable parts in the content are rearranged as selection objects 222. When doing so, by setting the size of the selection objects 222 larger than the size of the selectable parts, it is possible to facilitate operations of operation targets that are difficult to operate.

Note that although the operation area 220 is disposed at the right edge of the image display screen 200 in the example in FIG. 4, the present disclosure is not limited to this example. As one example, as shown in FIG. 6, the operation area 220 may be disposed at the left edge of the screen. The display position of the operation area 220 may be disposed with consideration to the user's dominant hand at a position on the image display screen 200 that is easy for the user to operate.

Also, when the selection objects 222 are arranged in a column in the operation area 220 as shown in FIG. 4, following a selection operation for the selection object 222, it is possible to execute a subsequent process in accordance with the next operation input by the user. As one example, as shown in FIG. 7, eight radial directions are defined with the currently selected selection object 222 (the cell in the center) as a standard. In this case, if it is detected that a hand making a gesture, a finger touching the image display screen 200, or the like has moved in one of such directions from the currently selected selection object 222, the data processing unit 160 carries out a process assigned in accordance with such direction of movement. As one example, in FIG. 7, if the user has moved in the fourth direction (to the right in the drawing) from the position of the selection object 222 currently selected, a process associated with the selection object 222 currently selected may be carried out. By doing so, it is possible for the user to carry out a process associated with the selection object 222 after the selection operation for the selection object 222, which improves operability for the user.

Note that as the operation that has the next process carried out after the selection operation of the selection object 222, aside from the example in FIG. 7, it is possible to indicate the next process via speech for example or to indicate the next process by changing the shape of the hand that makes the gesture. Alternatively, it is possible to indicate the next process by making a long press operation with the cursor 230 placed for a specified time or longer on the selection object 222 currently selected.

2-2. Variations for Operation Area

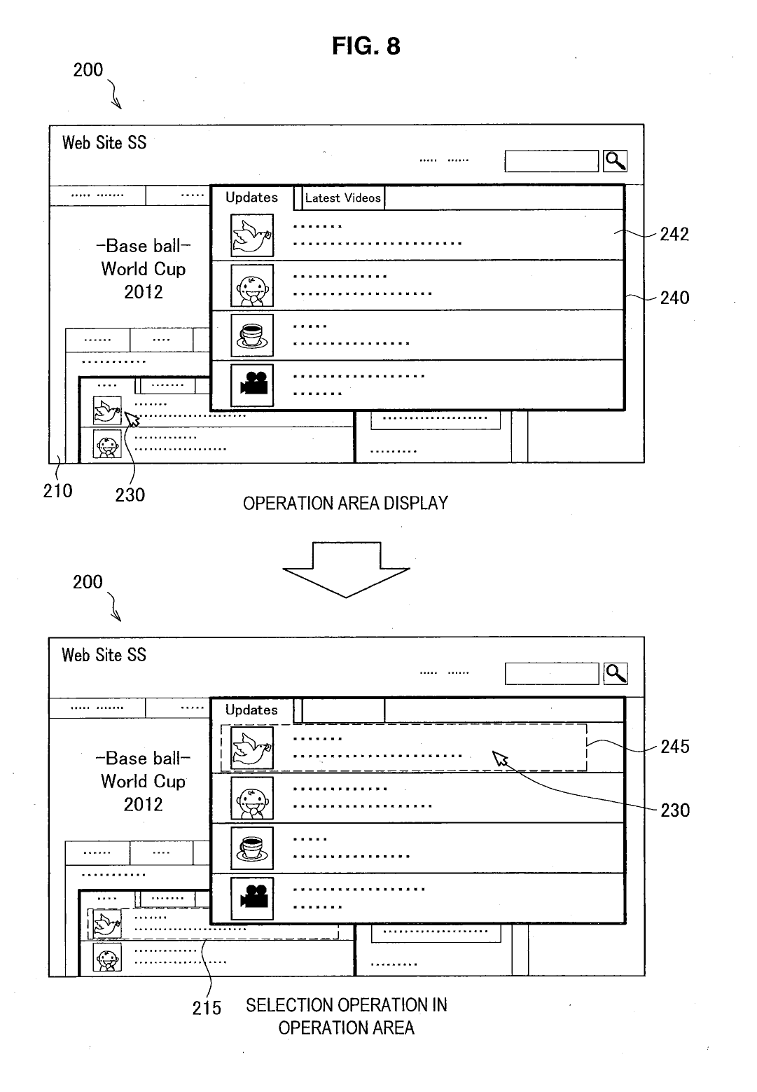

The layout of the operation area may be a layout aside from that shown in FIG. 4. The content subjected to operations may also be content aside from a webpage. Variations for the operation area for a variety of content will now be described with reference to FIGS. 8 to 14.

### (1) Enlarged Display of Selectable Parts

First, if the content is a website, as a variation to the operation area that differs to FIG. 4, it is possible to enlarge an area including the position indicated by the cursor 230 and display such enlarged part as an operation area 240. As one example, at the top in FIG. 8, the display area 210 displaying a website as normal is provided on the image display screen 200 of the image output unit 170. When the cursor 230 is placed on a selectable part of the webpage in the display area 210, the layout processing unit 166 enlarges the area of the selectable part around the position of the cursor 230 as it is and displays such enlarged part on the display area 210 as an operation area 240. Each selectable part in the operation area 240 is set as a selection object 242.

The operation area 240 is displayed next to the original region before enlargement. By doing so, it is possible for the user to easily view the original content before enlargement and the selection objects 242 in the operation area 240. It is also possible for the user to carry out an operation in the display area 210 and then an operation in the operation area 240 continuously by way of gestures, which improves operability. Also, by surrounding the operation area 240 and the original part before enlargement in the display area 210 with the same type of frame or the like, it is possible to clearly show the correspondence between the operation area 240 and such part of the display area 210.

When one of the selection objects 242 in the operation area 240 has been selected by the cursor 230, the selectable part corresponding to the display area 210 is selected. At this time, as shown at the bottom in FIG. 8, once a selection object 242 in the operation area 240 is selected, the correspondence display process that shows the correspondence between such selection object 242 and the selectable part in the display area 210 that corresponds to such selection object 242 is carried out. As shown at the bottom in FIG. 8 for example, the correspondence display may surround the selected object 242 currently selected by the cursor 230 and the selectable part corresponding to such with the same types of frame 245, 215 or may display both using the same type of highlight. By carrying out the correspondence display in this way, it is possible for the user to easily recognize what part of the content is being operated in the operation area 240, which makes it possible to improve operability in the operation area 240.

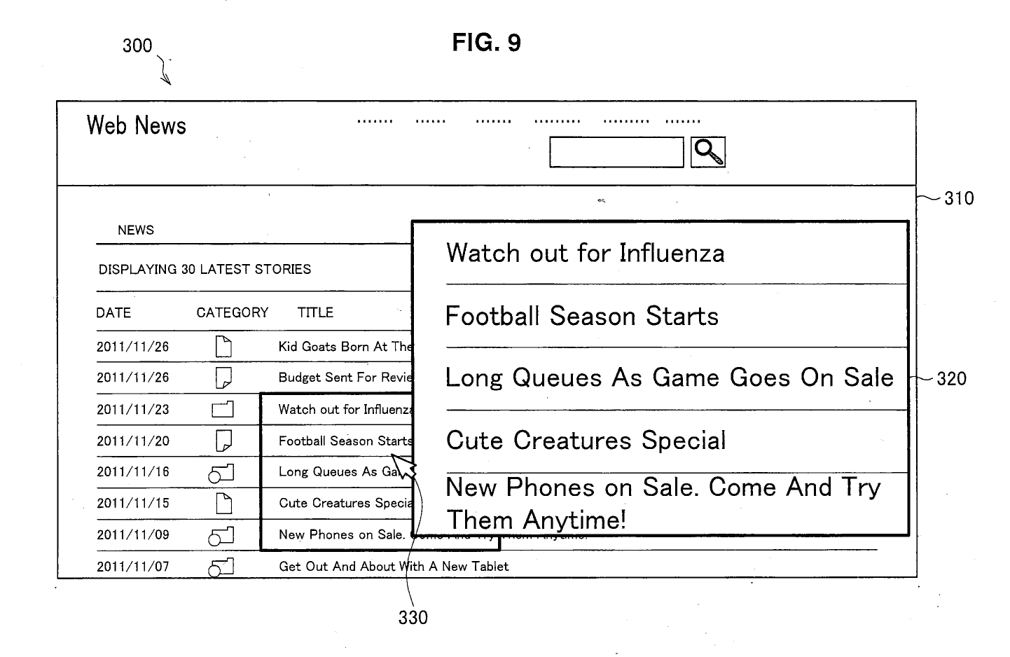

Aside from the configuration of a webpage such as that shown in FIG. 8, it is also possible to lay out an operation area 320 in the same way in an image display screen 300 such as that shown in FIG. 9, for example. That is, when a list of news is displayed in a display area 310, for example, an area including the position indicated by the cursor 330 is enlarged and displayed as the operation area 320. At this time, the operation area 320 is displayed next to the original region that has been enlarged. By doing so, since the respective items in the list of news whose selection areas are small in the display area 310 are displayed having been enlarged in the operation area 320, the selection areas are enlarged, which facilitates a selection operation for a desired item.

At this time, in the same way as in FIG. 8, the correspondence between the operation area 320 and the corresponding original part that was enlarged may be indicated by surrounding both with the same type of frame or the like. If one of the selection objects in the operation area 320 has been selected by the cursor 330, a correspondence display may be carried out to show the correspondence between the selected selection object and the selectable part of the display area 310 corresponding to such object. By doing so, it is possible for the user to easily recognize what part of the content is being operated in the operation area 320, which makes it possible to improve operability in the operation area 320.

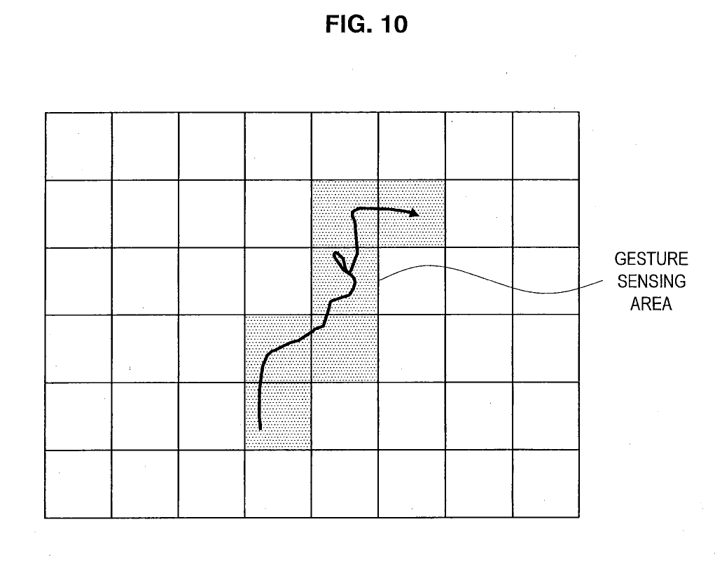

Note that by displaying an enlargement of part of the display area as the operation area as shown in FIGS. 8 and 9, it is possible as described above to carry out an operation in the display area and then an operation in the operation area continuously by way of gestures. Also, by increasing the selection area of each selection object in the operation area, the sensing areas where gestures are recognized are also enlarged, which makes it possible to recognize gesture operations even when the operation is imprecise as shown in FIG. 10 for example.

### (2) Application to a Small-Scale Terminal

From the viewpoint of operability, it is expected that an operation area 220 such as that shown in FIG. 4 will mainly be used when content is displayed on a television set, a display of a desktop computer, or a giant screen, for example. However, it is also possible to improve operability by rearranging selectable parts in content displayed in a display area as selection objects in an operation area in the same way on a small-scale terminal such as a mobile phone, a smartphone, or a tablet computer. Since the display area of the image output unit 170 is small for a small-scale terminal, it is especially effective to provide an operation area.

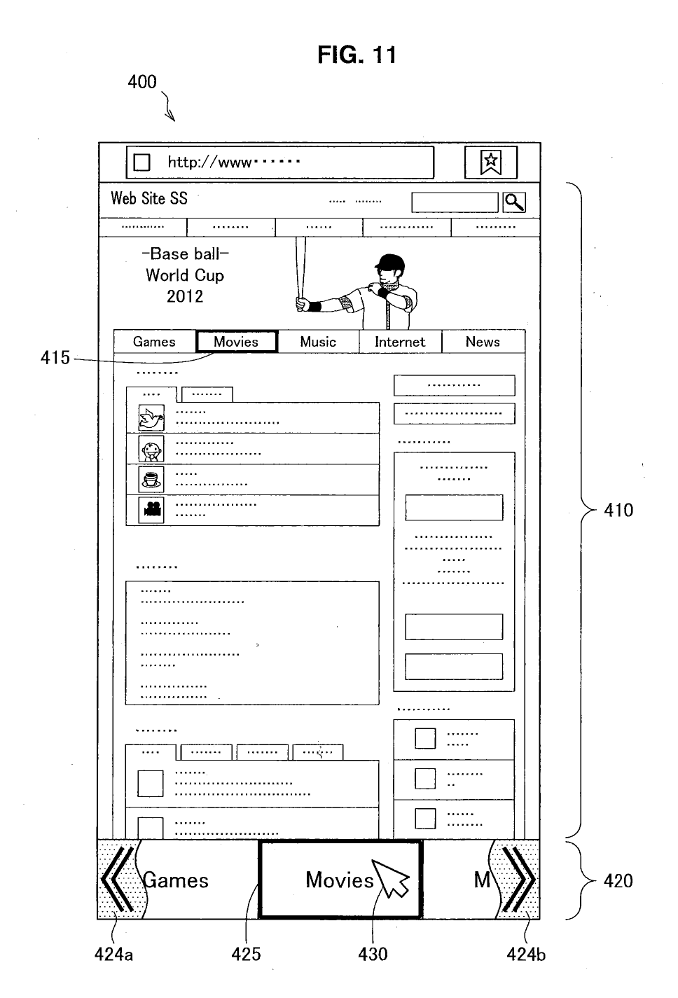

As one example, when making operations for content on a smartphone, as shown in FIG. 11, a display area 410 displaying content such as a webpage as normal and an operation area 420 in which selectable parts of the display area 410 are rearranged as selection objects are displayed on an image display screen 400. In the same way as the processing in FIG. 3, selectable parts are specified in the display area 410 and are rearranged into a line in the operation area 420 as selection objects. When doing so, from the viewpoint of operability, the operation area 420 may be provided in a lower part of the screen and the selection objects may be arranged into a horizontal row. That is, for a terminal such as that shown in FIG. 11, it is possible to improve operability by disposing the operation area 420 in the lower part of the screen with consideration to ease of operation when the user is holding the terminal.

If the number of selectable parts extracted from the display area 410 is large, and displaying all of such parts as selection objects of a specified size or larger in the operation area 420 is not possible, scroll buttons 424a, 424b are provided in the operation area 420. By pressing such scroll buttons 424a, 424b, the user can scroll the selection objects arranged in a row in the operation area 420 in a specified direction. By doing so, even when a large number of selectable parts are included in the content, it is possible to display every selection object corresponding to the selectable parts in a selectable manner in the operation area 420.

In addition, once a selection object in the operation area 420 has been selected by the cursor 430, a correspondence display (the frames 425, 415) that shows the correspondence between the selected selection object and the corresponding selectable part in the display area 410 may be carried out. By doing so, it is possible for the user to easily recognize what part of the content is being operated in the operation area 420, which makes it possible to improve operability in the operation area 420.

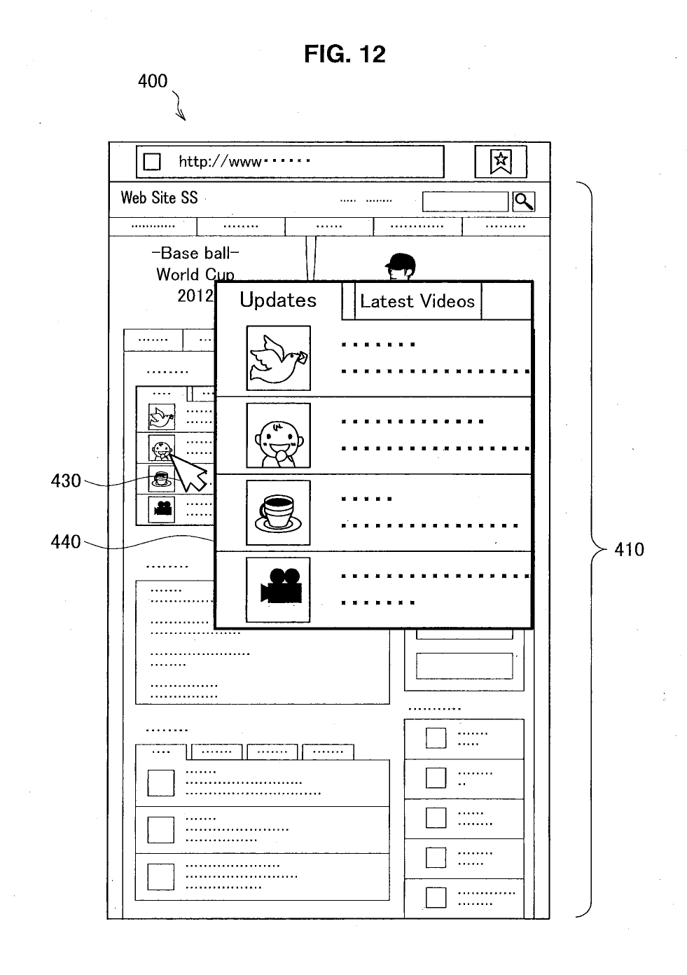

Alternatively, as shown in FIG. 12, it is also possible to have operations made for content on a smartphone by displaying an enlargement of an area including the position indicated by the cursor 430 as an operation area 440. As one example, as shown in FIG. 12, the display area 410 in which a webpage is displayed as normal is provided on the image display screen 400 of the image output unit 170. When the cursor 430 has been placed on a selectable part of the webpage in the display area 410, the layout processing unit 166 enlarges the selectable parts in an area in the vicinity of the position of the cursor 430 as they are and displays such enlargement on the display area 410 as the operation area 440. By doing so, the respective selectable parts in the operation area 440 become selection objects.

As one example, in the same way as in FIG. 8, the operation area 440 is displayed next to the original region before enlargement. By doing so, it is possible for the user to easily view the original content before enlargement and the selection objects in the operation area 440 at the same time. It also becomes possible to carry out an operation in the display area 410 and then an operation in the operation area 440 continuously by way of gestures, which improves operability. Also, by surrounding the operation area 440 and the original part of the display area 410 before enlargement with the same type of frame or the like, it is possible to clearly show the correspondence between such parts.

In addition, when a selection object in the operation area 440 is selected by the cursor 430, the corresponding selectable part in the display area 410 is selected. At this time, a correspondence display process that shows the correspondence between the selected selection object and the corresponding selectable part in the display area 410 is carried out. As examples, the correspondence display may attach the same type of frame to the selection object currently selected by the cursor 430 and the selectable part corresponding to such object or may highlight both the selected object and the selectable part in the same way. By carrying out such a correspondence display, it is possible for the user to easily recognize what part of the content is being operated in the operation area 440, which improves operability for the operation area 440.

### (3) Alternative Applications

As described above, although a case has been described where operability is improved by displaying an operation area together with a display area when operating content such as a webpage, the layout process carried out by the information processing apparatus 100 according to the present embodiment can also be used in other applications. As another example, the present embodiment may be used in a music playback application that plays back music data.

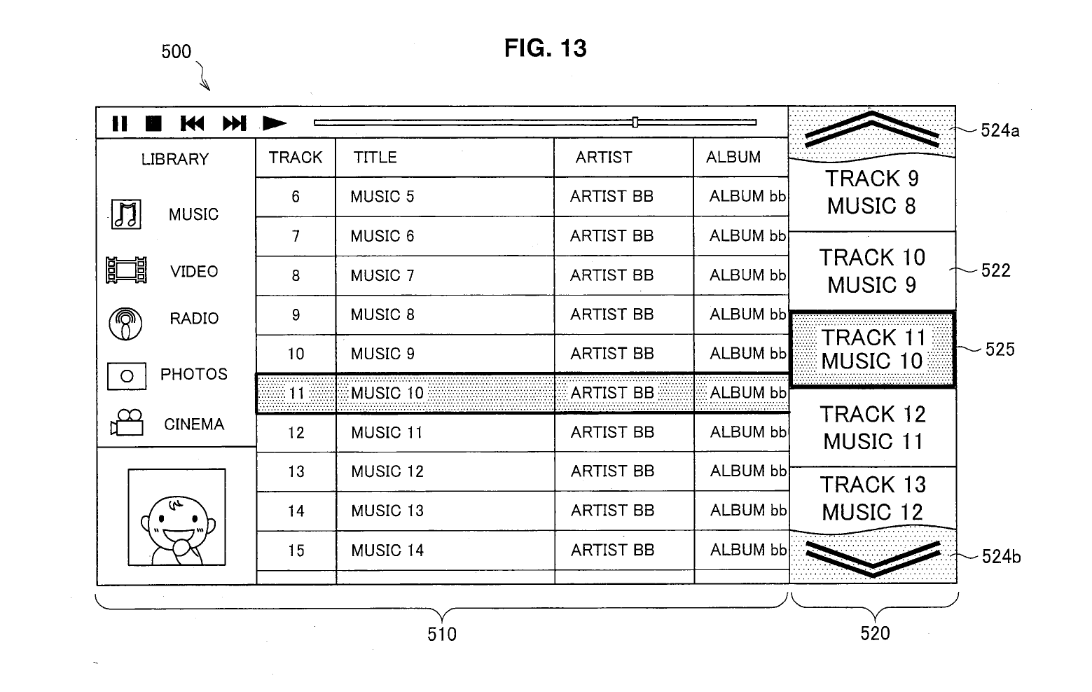

One example of an operation screen 500 of a music playback application is shown in FIG. 13. In the operation screen 500, a display area 510 displaying a list of music data and an operation area 520 in which selectable parts of the display area 510 are rearranged as selection objects are displayed. The track number of a song included on a music album, the song title, the artist name, the album name, and the like are displayed in a list in the display area 510 and it is possible to carry out operations such as playback for a song selected from the list. When doing so, since the selection areas for selecting a song on the display area 510 are small, it is easy for the user to make erroneous operations, making operations difficult. For this reason, using the information processing apparatus 100 according to the present embodiment, the respective songs in the list are set as selectable parts and such songs are rearranged as selection objects 522 in the operation area 520.

As shown in FIG. 13 for example, it is possible to rearrange selection objects 522 displaying a track number and title into a column in the operation area 520. If the number of songs displayed in the display area 510 is large and displaying all of the songs as selection objects 522 of a specified size or larger in the operation area 520 is not possible, scroll buttons 524a, 524b are provided in the operation area 520. By pressing such scroll buttons 524a, 524b, the user can scroll the selection objects 522 arranged in a column in the operation area 520 in a specified direction. By doing so, even when there are a large number of songs, it is possible to display all of the selection objects 522 corresponding to the respective songs in a selectable manner in the operation area 520.

Once a selection object 522 in the operation area 520 has been selected, a correspondence display (the frames 525, 515) that shows the correspondence between the selected selection object 522 and the corresponding selectable part in the display area 510 may be carried out. By doing so, it is possible for the user to easily recognize what part of the content is being operated in the operation area 520, which makes it possible to improve operability in the operation area 520.

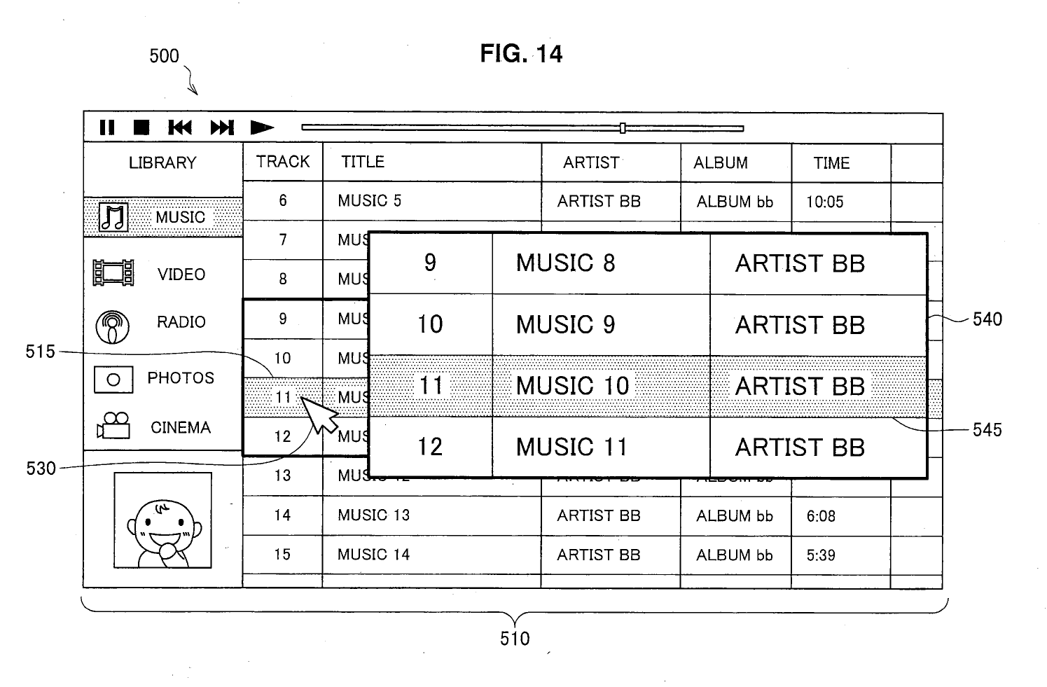

Alternatively, as shown in FIG. 14, it is also possible to display an enlargement of an area including the position indicated by the cursor 530 as an operation area 540. The display area 510 in which a list of songs is displayed as normal is provided on the image display screen 500 displayed by the image output unit 170. When the cursor 530 has been placed on a selectable part of the list of songs in the display area 510, the layout processing unit 166 enlarges the selectable parts in the vicinity of the position of the cursor 530 as it is and displays such enlargement on the display area 510 as the operation area 540. By doing so, the respective selectable parts in the operation area 540 become selection objects.

As one example, in the same way as in FIG. 8, the operation area 540 is displayed next to the original region before enlargement. By doing so, it is possible for the user to easily view the original content before enlargement and the selection objects in the operation area 540 at the same time. It also becomes possible to carry out an operation in the display area 510 and then an operation in the operation area 540 continuously by way of gestures, which improves operability. Also, by surrounding the operation area 540 and the original part of the display area 510 before enlargement with the same type of frame or the like, it is possible to clearly show the correspondence between such parts.

In addition, when a selection object in the operation area 540 is selected by the cursor 530, the corresponding selectable part in the display area 510 is selected. At this time, a correspondence display process that shows the correspondence between the selected selection object and the corresponding selectable part in the display area 510 is carried out. As examples, the correspondence display may attach the same type of frame to the selection object currently selected by the cursor 530 and the selectable part corresponding to such object or may highlight both selected object and selectable part in the same way. With such a correspondence display, it is possible for the user to easily recognize what part of the list of songs is being operated in the operation area 540, which improves operability for the operation area 540.

This completes the description of the configuration of the information processing apparatus 100 according to the present embodiment and the layout process for the operation area carried out by such information processing apparatus 100. As one example, the information processing apparatus 100 extracts selectable parts that can be subjected to gesture operations (i.e., can be selected) from content such as a webpage displayed in a display area and lays out such selectable parts as new selection objects to be subjected to gesture operations in an operation area. When doing so, by displaying the selection objects larger than the selectable parts displayed in the display area, the selection areas are enlarged and it becomes possible for the user to easily select a desired selectable part without making a precise operation. In addition, the correspondence between the selection object that is selected in the operation area and the original webpage displayed in the display area is also simultaneously displayed in an understandable manner. A correspondence display showing such correspondence may also be carried out. By doing so, it is possible to further improve operability.

### 3. Example Hardware Configuration

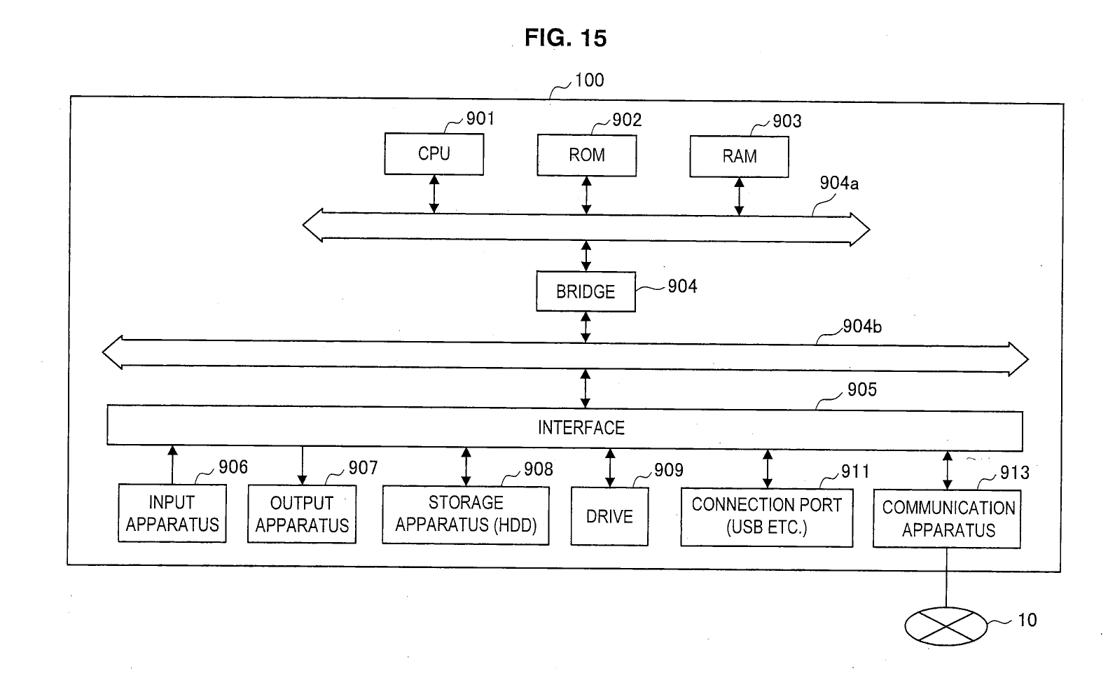

The processing by the information processing apparatus 100 according to the present embodiment can be carried out by hardware and can also be carried out by software. In the latter case, the information processing apparatus 100 can be configured as shown in FIG. 15. An example hardware configuration of the information processing apparatus 100 according to the present embodiment will now be described with reference to FIG. 15.

As described earlier, the information processing apparatus 100 according to the present embodiment can be realized by a processing apparatus such as a computer. As shown in FIG. 15, the information processing apparatus 100 includes a CPU (Central Processing Unit) 901, a ROM (Read Only Memory) 902, a RAM (Random Access Memory) 903, and a host bus 904a. The information processing apparatus 100 also includes a bridge 904, an external bus 904b, an interface 905, an input apparatus 906, an output apparatus 907, a storage apparatus (HDD) 908, a drive 909, a connection port 911, and a communication apparatus 913.

The CPU 901 functions as a computational processing apparatus and a control apparatus and controls the overall operation inside the information processing apparatus 100 in accordance with various programs. The CPU 901 may be a microprocessor. The ROM 902 stores programs, computation parameters, and the like used by the CPU 901. The RAM 903 temporarily stores programs used for execution by the CPU 901, parameters that change as appropriate during such execution, and the like. Such components are connected to one another by the host bus 904a that is composed of a CPU bus or the like.

The host bus 904a is connected via the bridge 904 to an external bus 904b which is a PCI (Peripheral Component Interconnect/Interface) bus or the like. Note that the host bus 904a, the bridge 904, and the external bus 904b do not need to be constructed separately and such functions may be implemented using a single bus.

The input apparatus 906 includes an input device, such as a mouse, a keyboard, a touch panel, a button or buttons, a microphone, a switch or switches, and a lever or levers, which enables the user to input information, an input control circuit that generates an input signal based on an input made by the user and outputs the input signal to the CPU 901, and the like. As examples, the output apparatus 907 includes a display apparatus such as a liquid crystal display (LCD) apparatus, an OLED (Organic Light Emitting Diode) apparatus, or a lamp or lamps and/or an audio output apparatus such as a speaker.

The storage apparatus 908 is one example of a storage unit of the information processing apparatus 100 and is an apparatus for storing data. The storage apparatus 908 may include a storage medium, a recording apparatus that records data onto the storage medium, a reading apparatus that reads data from the storage medium, and a deletion apparatus that deletes data recorded on the storage medium. The storage apparatus 908 is constructed of an HDD (Hard Disk Drive), for example. Such storage apparatus 908 drives a hard disk and stores programs executed by the CPU 901 and/or various data.

The drive 909 is a reader/writer for a storage medium and is built into or externally attached to the information processing apparatus 100. The drive 909 reads information recorded on a removable recording medium, such as a magnetic disk, an optical disc, a magneto-optical disc, or a semiconductor memory, that has been loaded and outputs such information to the RAM 903.

The connection port 911 is an interface connected to an external appliance and is a connection port for an external appliance that is capable of data transfer using USB (Universal Serial Bus), for example. The communication apparatus 913 is a communication interface constructed by a communication device or the like for connecting to a communication network 10, for example. Also, the communication apparatus 913 may be a wireless LAN (Local Area Network)-compliant communication apparatus, a wireless USB-compliant communication apparatus, or a wired communication apparatus that carries out communication using wires.

Although preferred embodiments of the present disclosure have been described above in detail with reference to the attached drawings, the technical scope of the present disclosure is not limited to such embodiments. It should be understood by those skilled in the art that various modifications, combinations, sub-combinations and alterations may occur depending on design requirements and other factors insofar as they are within the scope of the appended claims or the equivalents thereof.

Note that although in the embodiment described above, the selectable parts displayed as selection objects in the operation area of the image output unit 170 are decided in accordance with an operation position where the user has touched the operation area with his/her finger or the like, the present disclosure is not limited to this example. For example, it is possible for the image/audio input unit 120 and/or the gesture input unit 140 to be able to recognize a position where an input object has approached the image display screen. In such case, the layout processing unit 166 may rearrange the selectable parts present near the position where the input object has approached the display area of the image output unit 170 in an operation area as selection objects. If the position where the input object has approached the screen moves, the selection objects displayed in the operation area change in accordance with such movement of the input object. By doing so, the selectable parts in a display area about to be operated by the user are displayed in the operation area at faster timing, which makes it possible to further improve operability.

Additionally, the present technology may also be configured as below.

(1) An information processing apparatus including:

a selectable part analyzing unit analyzing selectable parts in a webpage displayed in a display area of a display unit; and

a layout processing unit rearranging the selectable parts as selection objects in an operation area.

(2) The information processing apparatus according to (1),

further including an operation analyzing unit analyzing an operation content based on an input result of an operation input unit that enables a user to make an operation input,

wherein the layout processing unit displays a correspondence display, which expresses correspondence between a selection object in the operation area that has been selected according to an analysis result of the operation analyzing unit and a corresponding selectable part of the webpage, for both the selection object and the selectable part.

(3) The information processing apparatus according to (2),

wherein the layout processing unit moves the correspondence displays displayed for both the selected selection object and the corresponding selectable part of the webpage in accordance with the operation input from the user.

(4) The information processing apparatus according to (3),

wherein the operation input from the user is an operation that moves a cursor in order to carry out a selection operation in the display area and the operation area, and

the correspondence displays are moved in accordance with a position of the cursor that moves based on the operation input from the user.

(5) The information processing apparatus according to (4),

wherein if a specified operation input has been made by the user in a state where one of the selection objects in the operation area is selected by the cursor, a process associated with the operation input is carried out.

(6) The information processing apparatus according to any one of (1) to (5),

wherein a size of the selection objects is larger than a size of the selectable parts in the webpage.

(7) The information processing apparatus according to any one of (1) to (6),

wherein the selectable part analyzing unit is operable, when a character size of the selectable parts in the webpage is smaller than a specified size, to have the layout processing unit generate the operation area in which the selection objects are rearranged.

(8) The information processing apparatus according to any one of (1) to (6),

wherein the selectable part analyzing unit is operable, when at least a specified number of the selectable parts are present in a specified area in the display area, to have the layout processing unit generate the operation area in which the selectable parts are rearranged.

(9) The information processing apparatus according to any one of (1) to (8),

wherein the display area and the operation area are displayed on the same screen.

(10) The information processing apparatus according to any one of (1) to (9),

wherein the layout processing unit displays the operation area next to the display area displaying the webpage.

(11) The information processing apparatus according to any one of (1) to (10),

wherein the selection objects are arranged in a line in the operation area.

(12) The information processing apparatus according to (11),

wherein the layout processing unit is operable when it is not possible to display, in the operation area, all of the selection objects corresponding to the selectable parts in the display area, to display the selection objects displayed in the operation area in a scrollable manner and, in keeping with scrolling of the selection objects in the operation area, to scroll the webpage in the display area so that the selectable parts corresponding to the selection objects displayed in the operation area are displayed in the display area.

(13) The information processing apparatus according to any one of (1) to (12),

wherein the layout processing unit decides the display position of the operation area on the display unit in accordance with an operation position of an input object used by a user to make an operation input.

(14) The information processing apparatus according to any one of (1) to (13),

wherein the layout processing unit is operable, when it is possible to acquire an approached state for the display unit as an input result of an operation input unit that enables a user to make an operation input, to rearrange the selectable parts present near a position where an input object has approached the display area of the display unit in the operation area as the selection objects.

The present disclosure contains subject matter related to that disclosed in Japanese Priority Patent Application JP 2012-050276 filed in the Japan Patent Office on Mar. 7, 2012, the entire content of which is hereby incorporated by reference.

What is claimed is:

1. An information processing apparatus comprising:
a selectable part analyzing unit analyzing selectable parts in a webpage displayed in a display area of a display unit; and
a layout processing unit rearranging the selectable parts as selection objects in an operation area.

2. The information processing apparatus according to claim 1,
further comprising an operation analyzing unit analyzing an operation content based on an input result of an operation input unit that enables a user to make an operation input,
wherein the layout processing unit displays a correspondence display, which expresses correspondence between a selection object in the operation area that has been selected according to an analysis result of the operation analyzing unit and a corresponding selectable part of the webpage, for both the selection object and the selectable part.

3. The information processing apparatus according to claim 2,
wherein the layout processing unit moves the correspondence displays displayed for both the selected selection object and the corresponding selectable part of the webpage in accordance with the operation input from the user.

4. The information processing apparatus according to claim 3,
wherein the operation input from the user is an operation that moves a cursor in order to carry out a selection operation in the display area and the operation area, and
the correspondence displays are moved in accordance with a position of the cursor that moves based on the operation input from the user.

5. The information processing apparatus according to claim 4,
wherein if a specified operation input has been made by the user in a state where one of the selection objects in the operation area is selected by the cursor, a process associated with the operation input is carried out.

6. The information processing apparatus according to claim 1,
wherein a size of the selection objects is larger than a size of the selectable parts in the webpage.

7. The information processing apparatus according to claim 1,
wherein the selectable part analyzing unit is operable, when a character size of the selectable parts in the webpage is smaller than a specified size, to have the layout processing unit generate the operation area in which the selection objects are rearranged.

8. The information processing apparatus according to claim 1,
wherein the selectable part analyzing unit is operable, when at least a specified number of the selectable parts are present in a specified area in the display area, to have the layout processing unit generate the operation area in which the selectable parts are rearranged.

9. The information processing apparatus according to claim 1,
wherein the display area and the operation area are displayed on the same screen.

10. The information processing apparatus according to claim 1,
wherein the layout processing unit displays the operation area next to the display area displaying the webpage.

11. The information processing apparatus according to claim 1,
wherein the selection objects are arranged in a line in the operation area.

12. The information processing apparatus according to claim 11,
wherein the layout processing unit is operable when it is not possible to display, in the operation area, all of the selection objects corresponding to the selectable parts in the display area, to display the selection objects displayed in the operation area in a scrollable manner and, in keeping with scrolling of the selection objects in the operation area, to scroll the webpage in the display area so that the selectable parts corresponding to the selection objects displayed in the operation area are displayed in the display area.

13. The information processing apparatus according to claim 1,
wherein the layout processing unit decides the display position of the operation area on the display unit in accordance with an operation position of an input object used by a user to make an operation input.

14. The information processing apparatus according to claim 1,
wherein the layout processing unit is operable, when it is possible to acquire an approached state for the display unit as an input result of an operation input unit that enables a user to make an operation input, to rearrange the selectable parts present near a position where an input object has approached the display area of the display unit in the operation area as the selection objects.

15. An information processing method comprising:
analyzing selectable parts in a webpage displayed in a display area of a display unit; and
rearranging the selectable parts as selection objects in an operation area.

16. A computer program causing a computer to function as an information processing apparatus comprising:
a selectable part analyzing unit analyzing selectable parts in a webpage displayed in a display area of a display unit; and
a layout processing unit rearranging the selectable parts as selection objects in an operation area.
